(19) United States
(12) Patent Application Publication
(10) Pub. No.: US 2005/0051637 A1
(43) Pub. Date: Mar. 10, 2005

(54) System and a method for controlling room temperature

(76) Inventor: Ole Hansen, Humlebaek (DK)

Correspondence Address: HARNESS, DICKEY & PIERCE, P.L.C., P.O. BOX 8910, RESTON, VA, 20195, US

(21) Appl. No.: 10/490,473

(22) PCT Filed: Sep. 24, 2002
(86) PCT No.: PCT/DK02/00629

(30) Foreign Application Priority Data
Sep. 24, 2001 (DK) PA 2001 01385

(51) Int. Cl. G05D 23/19

(52) U.S. Cl. 236/1 C; 236/91 D

(57) ABSTRACT

According to the invention a system and method for controlling room temperature is provided wherein a set-point value for the temperature of a room is set. The temperature of a heating and/or cooling medium, i.e. the flow temperature, is determined and utilized by a control system to change the set-point value. Due to the changing of the set-point value, the controlling of the temperature is less influenced by thermal delay inertia which otherwise can cause the room temperature to rise to a value far beyond the set-point value. The invention is in particularly concerned with temperature control in buildings with a central heating or cooling installation.

### TECHNICAL FIELD

The present invention relates to systems and methods for controlling room temperature, in particular in buildings with a central heating or cooling installation.

### BACKGROUND OF THE INVENTION

In a building having a central heating and/or cooling installation, the feed temperature of a heating and/or cooling medium, usually water, is dependent from the rate of heat exchange in a heating or cooling installation, e.g. an oil-fired burner, and from the heat consumption of the various heat consuming devices of the building, such as radiators and baths. Thus, the larger the heat consumption, the lower the heating and/or cooling medium temperature.

U.S. Pat. No. 3,567,115 discloses a zone temperature control system, wherein each zone has a thermostat with two electrical outputs. The thermostat of each zone is electrically connected so that one output controls the zone damper motor which adjusts the flow of air to its zone. The second electrical output of the zone thermostat having the greatest load is connected to control the temperature of the air being delivered to all the zones from a central source.

### SUMMARY OF THE INVENTION

It is an object of the invention to provide an improved system and method for controlling a temperature of a room or a plurality of rooms, in particular with the aim of reducing overshoot when changing a room temperature.

Thus, in a first aspect the invention provides a system for controlling a temperature of a room, the system comprising a heating/and or cooling system with a control system for at least partly controlling the temperature of the room, the system comprising:
a temperature-setting device for setting a set-point value for the temperature of the room,
a room temperature sensor for determining a current room temperature,
a supply medium temperature sensor for sensing a temperature of a heating and/or cooling medium of the system,
the control system being adapted to determine if the set-point value for the room temperature and the current room temperature differ with more than a given difference and to control the heating and/or cooling system so as to change the current room temperature, the control system being further adapted to change the set-point value for the temperature of the room based on the temperature of the heating and/or cooling medium.

Where in the present context, the term “room” is used, this should be interpreted broadly. Thus, the term comprises any room, zone or other well-defined space or area.

Thereby the set-point value for the room temperature is made dependent on the feed temperature, in the literature also referred to as the flow temperature, of the heating or cooling medium, as the set-point value is manipulated from the set value to a fictive value which depends on the feed temperature of the heating or cooling medium.

For example, if a room is to be warmed up from 19° C. to an actually set set-point value of 23° C., and the feed temperature of the heating medium is 60° C., the fictive set-point value may be 22.4° C. In that case, a furnace of the heating system switches to an off state once the actual room temperature has reached the fictive set-point value of 22.4° C. Due to thermal inertia, the actual room temperature will keep rising, even though the furnace is in a off state and provides no heat to the room. However, as the fictive set-point value is lower than the actually set set-point value, a temperature overshoot in the room may be avoided or at least reduced. In other words, if no fictive set-point value had been set, and if the furnace would have switched to its off state once the room temperature had arrived at the actually set set-point value, the thermal delay inertia would have caused the room temperature to rise to a value far beyond the set-point value.

In another example, where the room is to be warmed up from 19° C. to the actually set set-point value of 23° C., and the feed temperature of the heating medium is only 40° C., the fictive set-point value may be higher than in the above first example, such as 22.8° C. In that case, a furnace of the heating system switches to an off state once the actual room temperature has reached the fictive set-point value of 22.8° C. As in the above example, due to a thermal delay inertia, the actual room temperature will keep rising, but the rate of temperature rise will be smaller than in the above example, as the feed temperature is lower.

In one embodiment of the invention, the fictive set-point value, T_{fictive}, may be expressed as a function of the actually set set-point value, Tₛₑₜ, and the feed temperature of the heating system, T_{feed}, T_{fictive}=f (Tₛₑₜ, T_{feed}). As an example, the following expression may link the fictive set-point value to the feed temperature:
T_{fictive}=Tₛₑₜ−c*(T_{feed}−Tᵣₒₒₘ)
where Tᵣₒₒₘ is the current room temperature, and where c is a constant which, in most embodiments, is between 0.001 and 0.5, such as between 0.005 and 0.1, such as between 0.008 and 0.03, such as between 0.009 and 0.02, such as approximately 0.01, provided degrees Celcius is used as a unit for the temperature values in the above expression.

The feed temperature of the heating and/or cooling medium may be determined by means of a sensor which may log the feed temperature and send a signal representative of the feed temperature to the control system.

The system of the invention may alternatively or additionally be adapted to log or record the feed temperature over relatively long periods of time. Thus, the feed temperature may be logged over two hours, or over-periods of time up to 24 hours. The fictive set-point value may be changed in dependence from the logged temperatures. For example, if an average of the logged temperatures exceeds a certain level, the fictive set-point value may be changed in accordance with the average. As an example, during a winter period the average feed temperature is usually high, e.g. 60° C., which causes the fictive set-point value to be low in average. If, for example, the constant c in the expression T_{fictive}=Tₛₑₜ−c*(T_{feed}−Tᵣₒₒₘ) is 0.1, and the actually set set-point value Tₛₑₜ is 23° C., and the current room temperature is 20° C., the fictive set-point value, T_{fictive} is 23° C.-0.1*(60° C.-20° C.)=19° C. However, a room temperature of 19° C. is obviously not the desired room temperature of 23° C. Therefore, the feed temperature logging and averaging over relatively long periods of time may be used to compensate for such a undesired low room temperature in such a way that the average fictive set-point is appropriately increased. For example, the constant c may be dependent on the average feed temperature, so that a high feed temperature results in a low value for c, whereas a low feed temperature results in a high value for c.

In a district heating system, it may also be advantageous to change the set-point value of the temperature. In such a system, individual feed temperature sensors, i.e. sensors for determining the feed temperature of the cooling and/or heating medium, are preferably arranged in each room, in which case the set-point value for the temperature is individually changed in respect of each room. Accordingly, the system of the present invention may be applied in a direct or indirect district heating system with or without mixing valve.

The room temperature sensor may be comprised in or comprise a thermostat of the type known per se. The heating and/or cooling medium may be water.

The system may be adapted to control the temperature of a plurality of rooms connected to a central heating and/or cooling unit, such as on oil- or gas fired burner of a building. A heating and/or cooling device, usually a radiator, may be provided in each room.

The control system may comprise a converter for changing the set-point value, whereby the converter may be mounted near or in the central heating and/or cooling unit.

Further, a converter for changing the set-point value may be provided, in which case the converter is preferably mounted near or in heating and/or cooling device of the room.

The room temperature sensor may be comprised in or comprise an on/off thermostat or a proportional regulator. The temperature sensor may comprise a diode or a rectifier. Each room temperature may be controlled by a proportional regulator for regulating the transport of heating and/or cooling medium through the room, e.g. through a radiator of the room.

A start/stop relay or a time delaying relay may be provided in a start/stop input device in the central heating and/or cooling unit. Thus, the start/stop relay or the time delaying relay may be adapted to cause a delay in the control system's activation of the central heating and/or cooling unit. In preferred embodiments of the invention, the delay may be a function of a temperature input, such as the temperature of the temperature of the heating and/or cooling medium or an outdoor temperature. An appropriate heating and/or cooling medium temperature sensor and an appropriate outdoor temperature sensor may be provided. In such embodiments, relatively long intervals may be provided between cycles of, e.g., a furnace comprised in a central heating and/or cooling unit if the load on the system is relatively low, i.e. if the outdoor temperature is relatively high. Usually, if the outdoor temperature is relatively high, the feed temperature is relatively low, in which case a low feed temperature is indicative of a high outdoor temperature, and vice versa. Relatively short intervals may be provided between cycles of the furnace if the load on the system is relatively high.

A valve with an on/off regulator may be provided for the central heating and/or cooling unit. Alternatively, a valve with a proportional regulator may be provided for the central heating and/or cooling unit. In such embodiments, the control system may be adapted to vary a settling time of the proportional regulator. The control system may, alternatively or additionally, be adapted to vary or dampen the amplitudes of the cycles of the proportional regulator. The settling time and/or the amplitudes may be varied as a function of the temperature of the heating and/or cooling medium, such as for example an average of a feed and a return temperature of the medium.

The on/off regulator and/or the proportional regulator are preferably electrical regulators. The valve may comprise a vapour-filled bellow with the supply medium temperature sensor, the vapour-filled bellow having a contact or device for outputting a valve position. The working principle of a vapour-filled bellow is as follows: based on a modulating proportional principle, a drop in ambient temperature causes the valve to open. This increases the supply of hot water or low-pressure stream entering the radiator. Conversely, a rise in ambient temperature causes the valve to close. This decreases the supply of hot water or low-pressure steam entering the radiator.

A plurality of room temperature sensors may be provided in a plurality of rooms or zones, whereby the outputs of the room temperature sensors are preferably coupled in parallel to the control system. Analogously, a plurality of temperature setting devices may be provided in a plurality of rooms or zones, whereby input to the temperature setting devices are preferably coupled in parallel to the control system.

The setting of the set-point temperature may be external, i.e. remote from a radiator and/or control system elements in a room. External room temperature sensors may be provided, i.e. remote from a radiator and/or control system elements in a room. Data may be transmitted by wireless devices between the control system and at least one of said devices, sensors, valves, and regulators. Also, energy may be supplied to such devices, sensors, valves and regulators by wireless energy transmission, such as by means of low energy laser light beams, or by means of solar cells or photovoltic cells. Data may be transmitted by means of so-called powerline communication, i.e. communication via conventional 110 or 220 V power plugs and power lines.

A piezoelectric element or a thermo element may be provided for converting thermal energy to electric or mechanical energy. Thus, temperature changes, e.g. in the feed temperature, may be used for generating power for the control system.

In an application of the invention comprising a plurality of rooms, there is no need to provide data communication from the room temperature sensor of every single room to the furnace. Thus, not all room temperature sensors need to be adapted to provide a control signal to the furnace.

In a second aspect, the invention provides a method for controlling a temperature of a room, the temperature of the room being at least partly controllable by a heating and/or cooling system, the method comprising the steps of:
defining a set-point value for the temperature of the room,
determining a current room temperature, if the set-point value for the room temperature and the current room temperature differ with more than a given difference: controlling the heating and/or cooling system so as to change the current room temperature,
said controlling of the heating and/or cooling system comprising the steps of: determining a temperature of a heating and/or cooling medium which is supplied to the room by the heating and/or cooling system,
changing the set-point value for the temperature of the room based on the temperature of the heating and/or cooling medium.

It should be understood that the steps and operations made possible by the various features of the system according to the first aspect of the invention may also be steps and operations in the method according to the second aspect of the invention.

In a third aspect, the invention provides a system for individually controlling temperatures of at least two rooms, the system comprising a central heating or cooling unit and a control system for at least partly controlling the temperature of each of the rooms, the system further comprising, in each room:
a temperature-setting device for setting a set-point value for the temperature of the room,
a room temperature sensor for determining a current room temperature,
an anticipator for causing the room temperature sensor to output a signal representing a temperature which is different from the current room temperature,
the control system being operatively connected to the room temperature sensor of each room and to the anticipator of each room, whereby operation of the central heating or cooling unit may be controlled in accordance with signals received by the control system from each room temperature sensor, and whereby each anticipator may be centrally activated by the control system.

In a fourth aspect, the invention provides a method for individually controlling temperatures of at least two rooms, the temperatures being at least partly controllable by a cooling and/or heating system comprising a central heating or cooling unit, a control system, and, in each room, a room temperature sensor and an anticipator, the method comprising:
defining a set-point value for the temperature of each room, determining, by means of each room temperature sensor, a current room temperature of each room,
causing, by means of each anticipator, each room temperature sensor to output a signal representing a temperature which is different from the current room temperature,
operating the central heating or cooling unit in accordance with signals received by the control system from each room temperature sensor, and
controlling each anticipator by means of the control system.

Where in the present context the term anticipator is used, this also includes so-called accelerators.

The step of controlling each anticipator may comprise activating all anticipators in case at least one room temperature differs more than a predetermined difference from the current room temperature of that room. The step of controlling each anticipator may further comprise de-activating each anticipator in case no room temperature differs more than a predetermined difference from the current room temperature of that room. Thus, the temperature of the heating and/or cooling medium provided to the rooms is controlled or governed by the room having the largest need for supply of heating or cooling medium, whereas the other room or rooms may be kept at or close to their set-point temperature.

The above features of the method of the fourth aspect of the invention also apply to the method according to the third aspect of the invention.

It should be understood that any feature or functionality described in connection with the first and second aspects of the invention may also be provided in or by the third and fourth aspects of the invention and vice versa.

In a fifth aspect, the invention provides a system for controlling a feed temperature in a heating system which comprises:
a control system for setting a set-point value of a temperature of the room, the system comprising:
a temperature-setting device for setting a set-point value for the temperature of the room, the control system being adapted to change the set-point value for the temperature of the room based on the temperature of the heating and/or cooling medium, and thereby to control said feed temperature.

In a sixth aspect, the invention provides method of controlling a feed temperature in a heating system which comprises:
a control system for setting a set-point value of a temperature of the room, the system comprising:
a temperature-setting device for setting a set-point value for the temperature of the room, the method comprising: changing the set-point value for the temperature of the room based on the temperature of the heating and/or cooling medium, whereby, the feed temperature remains substantially constant once a steady-state room temperature cycle has been reached.

It should be understood that any feature or functionality described in connection with the first and second aspects of the invention may also be provided in or by the fifth and sixth aspects of the invention.

In particular, it should be understood that the fifth and sixth aspects of the invention incorporate the feature of changing the set-point value for the room temperature which, in preferred embodiments of the 1st-6th aspects of the invention results in the advantageous effect that the lowest possible feed temperature in a heating system may be reached once a steady-state temperature cycle has been reached. In applications of the invention, wherein several rooms are supplied by the system, the lowest possible feed temperature for the most loaded room, i.e. the room with the largest heat exchange, may be reached.

In a further aspect, the invention provides an installation for controlling a central heating and/or cooling system, the heating and/or cooling system being adapted to convey a heating and/or cooling medium through the system, the installation comprising:
a control system for controlling operation of the heating and/or cooling system, the control system being adapted to change a set-point value for a room temperature based on the temperature of the heating and/or cooling medium,
a start/stop relay or a time delaying relay in a start/stop input device in the central heating and/or cooling system, the start/stop relay or the time delaying relay being adapted to cause a delay in the control system's activation of the central heating and/or cooling system,
wherein the control system is adapted to vary the delay in accordance with a temperature input.

In a further aspect, the invention provides an installation for controlling a central heating and/or cooling system, the heating and/or cooling system being adapted to convey a heating and/or cooling medium through the system, the installation comprising:
a control system for controlling operation of the heating and/or cooling system, the control system being adapted to change a set-point value for a room temperature based on the temperature of the heating and/or cooling medium,
a start/stop relay or a time delaying relay in a start/stop input device in the central heating and/or cooling system, the start/stop relay or the time delaying relay being adapted to cause a delay in the control system's activation of the central heating and/or cooling system,
wherein the control system is adapted to vary the delay in accordance with a temperature input.

The invention also provides a method for controlling operation of a central heating and/or cooling system, the heating and/or cooling system being adapted to convey a heating and/or cooling medium through the system, the method comprising:
changing a set-point value for a room temperature based on the temperature of the heating and/or cooling medium,
the control system comprising a start/stop relay or a time delaying relay in a start/stop input device in the central heating and/or cooling system, the start/stop relay or the time delaying relay being adapted to cause a delay in the control system's activation of the central heating and/or cooling system, the method further comprising:
varying the delay in accordance with a temperature input

Thus, the start/stop relay or the time delaying relay may be adapted to cause a delay in the control system's activation of the central heating and/or cooling unit. This feature is described in detail above in connection with the fist aspect of the invention.

### DESCRIPTION OF THE DRAWINGS

FIG. 1 illustrates a system according to the first aspect of the invention wherein on/off regulators are used for regulating the room temperature and for operating the furnace and through that the flow temperature. In FIGS. 1-4, the furnace constitutes a central heating unit.

FIG. 2 illustrates a system according to the first aspect of the invention wherein proportional regulators are used for regulating the room temperature and for operating the furnace and through that the flow temperature. In FIG. 2, the furnace is a modulating furnace, i.e. an ungraduated furnace.

FIG. 3 illustrates a system according to the first aspect of the invention wherein the system is expanded to a plurality of zones and wherein on/off regulators are used for regulating the room temperatures and for operating the furnace and through that the flow temperature. The setpoint correction unit synchronises the cycles of the room thermostats, so that the radiator with the highest heat demand governs operation of the furnace.

FIG. 4 illustrates a system according to the first aspect of the invention wherein the system is expanded to a plurality of zones and wherein proportional regulators are used for regulating the room temperatures and for operating the furnace and through that the flow temperature. As in the system of FIG. 3, the setpoint correction unit synchronises the operation of the room thermostats, so that the radiator with the highest heat demand governs operation of the furnace.

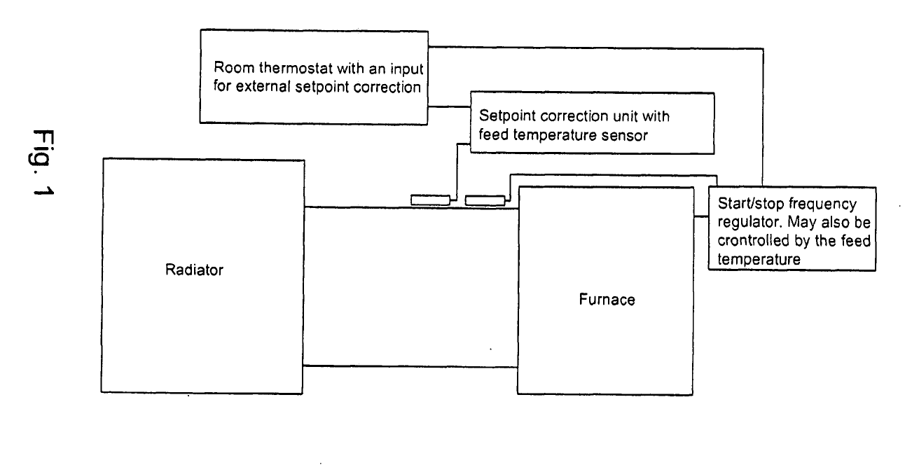

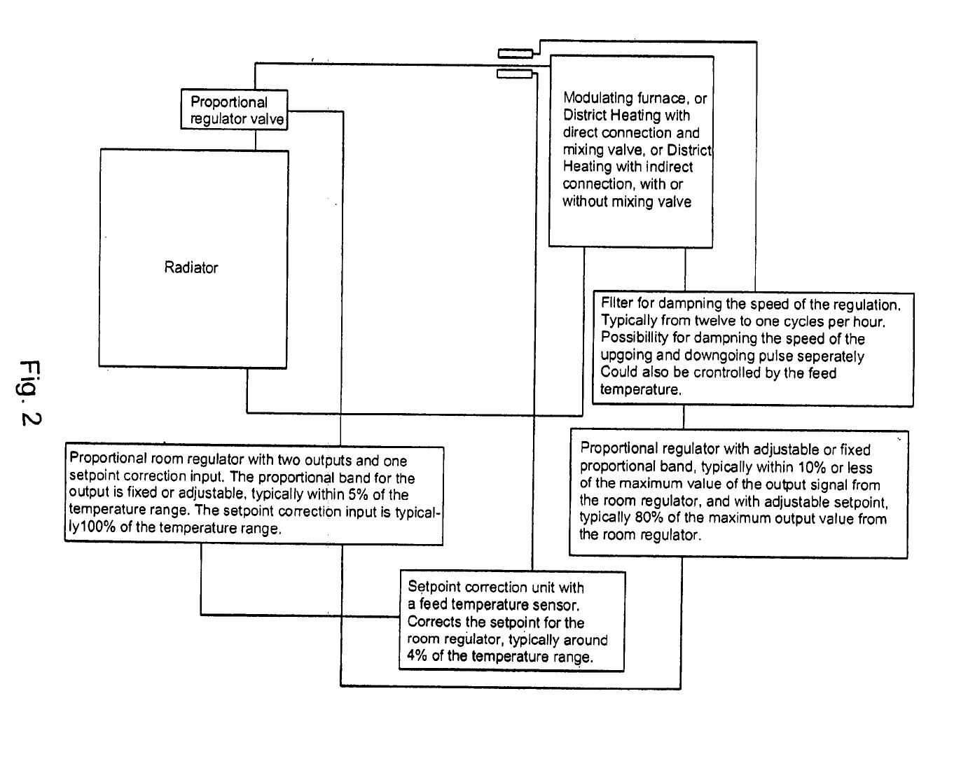

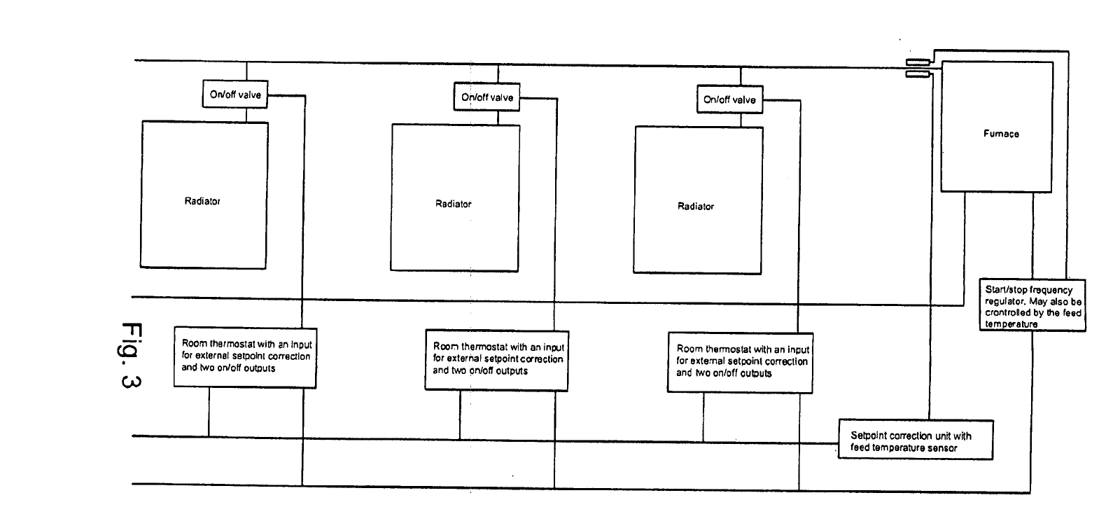

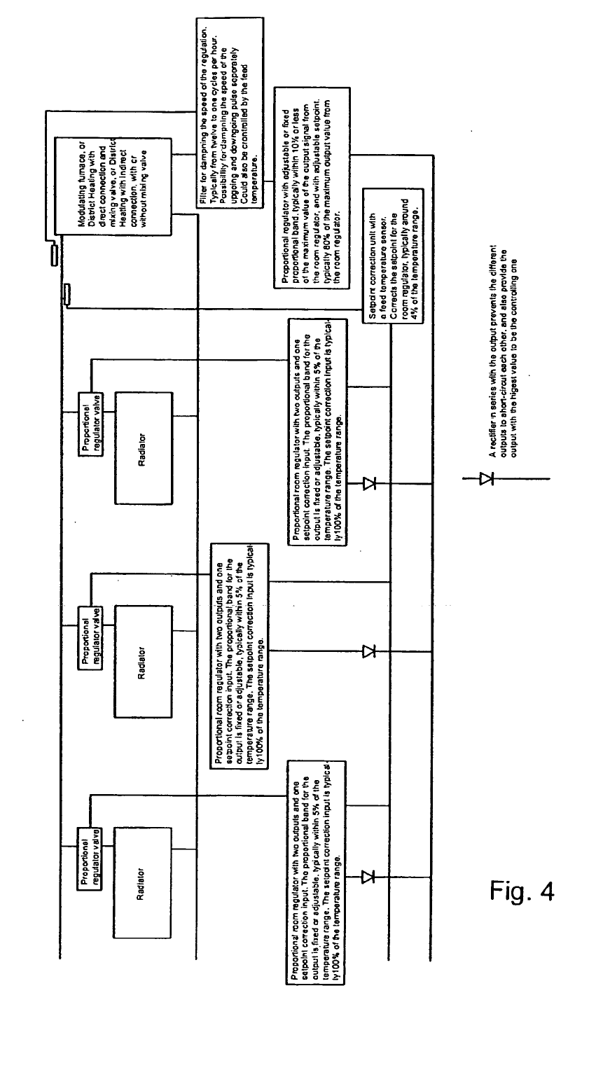

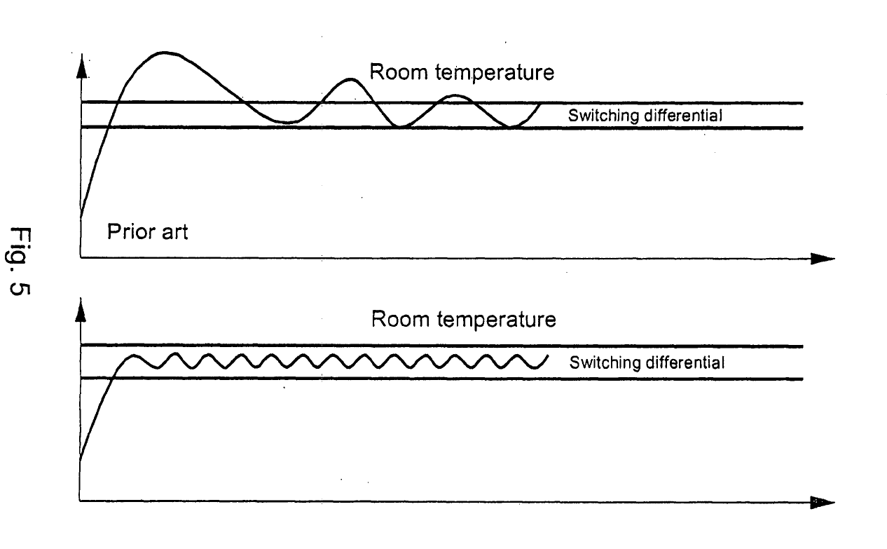

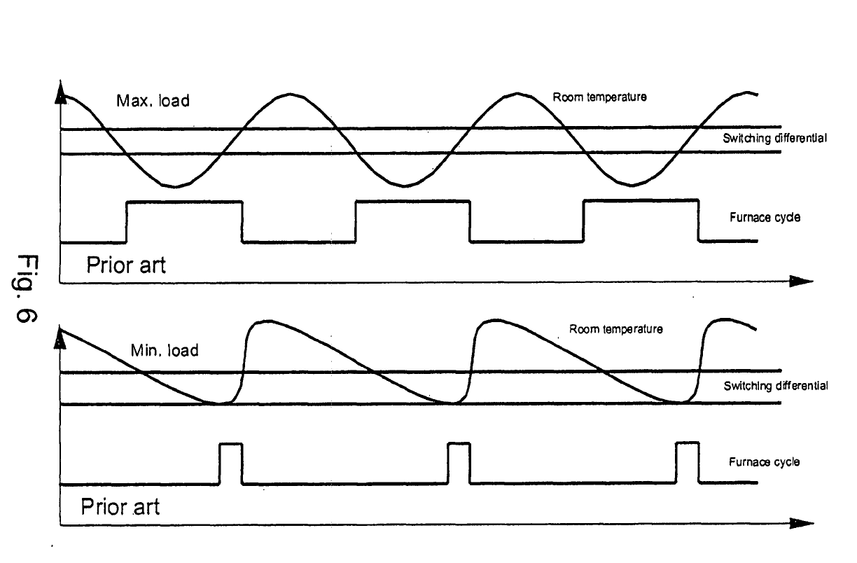

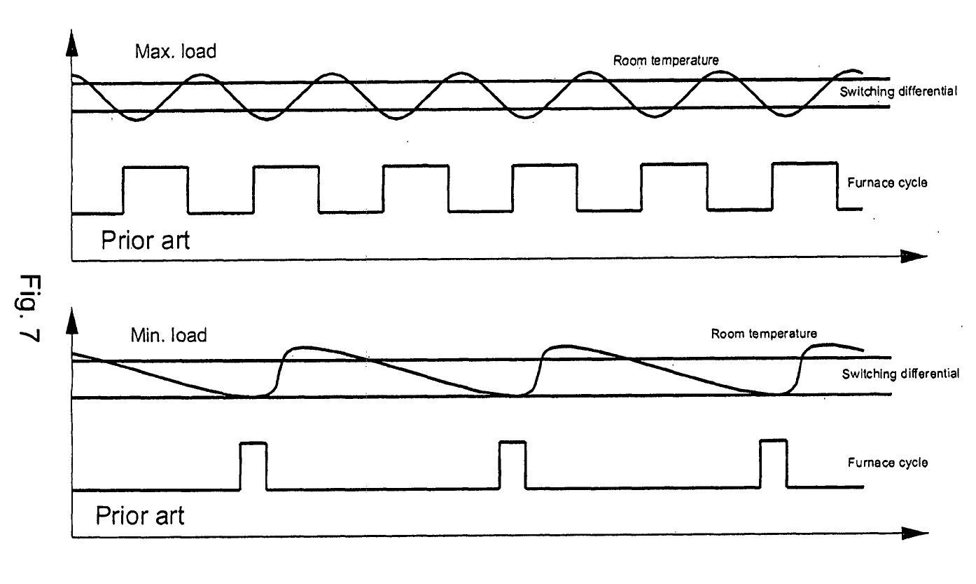

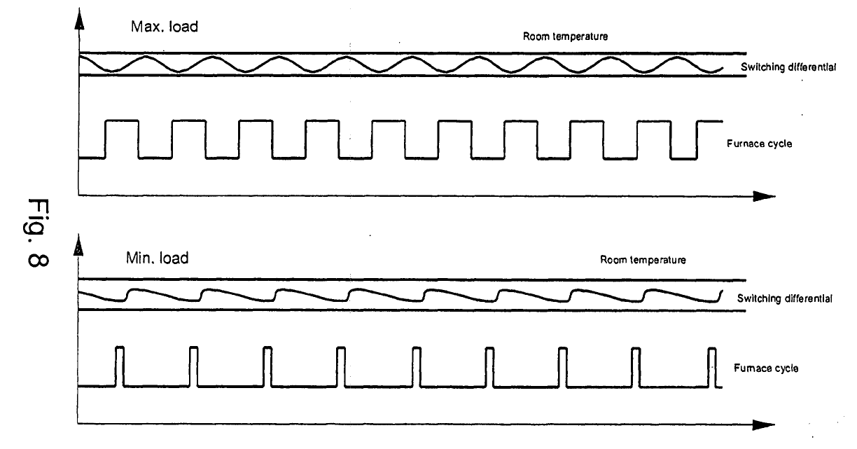

In FIG. 5, the upper curve illustrates the temperature variation overtime in a typical prior art system over time when the temperature is being raised from a low value to a higher value after a room temperature set-point has been set and heating initiated, or when the set-point value has been raised from one value to a second higher value. The lower curve in FIG. 5 illustrates the variation conferred by a system according to the first aspect of the invention. As illustrated, the temperature overshoot is reduced, and control of the room temperature is more accurate. In FIG. 8, the upper curve illustrates room temperature variation and furnace cycles over time in a system according to the first aspect of the invention. In the upper diagram, a typical situation at maximum load, i.e. maximum heat exchange, and corresponding furnace cycle is shown. A typical situation at minimum load and corresponding furnace cycle is shown in the lower diagram.

FIG. 6 illustrates room temperature variation and furnace cycles over time in typical prior art systems. In the upper diagram, a typical situation at maximum load, i.e. maximum heat exchange, and corresponding furnace cycle is shown. A typical situation at minimum load and corresponding furnace cycle is shown in the lower diagram.

FIG. 7 illustrates room temperature variation and furnace cycles over time in a system according to the third aspect of the invention. In the upper diagram, a typical situation at maximum load, i.e. maximum heat exchange, and corresponding furnace cycle is shown. A typical situation at minimum load and corresponding furnace cycle is shown in the lower diagram. When comparing the upper and lower diagrams in FIGS. 6 and 7 it is apparent that the temperature overshoot is reduced in the system according to the invention, and the frequency of the furnace cycles is increased. Likewise, the temperature overshoot is reduced, and the frequency of the furnace cycles may be increased at minimum load.

1-35. (Cancelled)

36. A system for controlling a temperature of a plurality of rooms, the system comprising a heating and/or cooling system with a central heating and/or cooling unit and a control system for at least partly controlling the temperature of the rooms, the system comprising a supply medium temperature sensor for sensing a feed temperature of a heating and/or cooling medium being fed to the room by the heating and cooling system, and in each room:
a temperature-setting device for setting a set-point value for the temperature of the room, and
a room temperature sensor for determining a current room temperature,
the control system being adapted for each room to determine a control value representing a difference between the set-point value for the room temperature and the current room temperature, and to control the heating and/or cooling system based on the control values so as to change the current room temperatures, characterised in that the control system is further adapted to change the control values for each room.

37. A system according to claim 36, wherein the control value is changed based on the temperature of the heating and/or cooling medium.

38. A system according to claim 36, further comprising an anticipator for causing the room temperature sensors to output a signal representing a temperature which is different from the current room temperature, the control system being operatively connected to the room temperature sensors of each room and to the anticipators of each room, whereby operation of the central heating or cooling unit may be controlled in accordance with signals received by the control system from each room temperature sensor, and whereby each anticipator may be centrally activated by the control system, and wherein the control values are changed by activating an anticipator to change the output signal of the temperature sensor.

39. A system according to claim 36, wherein the room temperature sensor comprises or is comprised in an on/off thermostat.

40. A system according to claim 36, wherein each room temperature is controlled by a proportional regulator.

41. A system according to claim 36, further comprising a valve with a proportional regulator for the central heating and/or cooling unit, and wherein the valve comprises a vapour-filled bellow with the supply medium temperature sensor, the vapour-filled bellow having a contact or device for outputting a valve position.

42. A system according to claim 36, wherein outputs of the room temperature sensors are coupled in parallel to the control system, and wherein an output of the temperature sensor comprises a diode or a rectifier.

43. A system according to claim 36, wherein input to the temperature setting devices are coupled in parallel to the control system to allow changes to the control value of each temperature setting device in parallel.

44. A system according to claim 42, further comprising a start/stop relay or a time delaying relay in a start/stop input device in the central heating and/or cooling unit, the start/stop relay or the time delaying relay being adapted to cause a delay in the control system's activation of the central heating and/or cooling unit.

45. A system according to claim 44, wherein the control system is adapted to vary the delay in accordance with a temperature input.

46. A system according to claim 45, wherein the temperature input comprises a signal representative of the temperature of the heating and/or cooling medium.

47. A system according to claim 45, wherein the temperature input comprises a signal representative of an outdoor temperature.

48. A system according to claim 42, further comprising a proportional regulator for regulating the central heating and/or cooling unit.

49. A system according to claim 48, wherein the control system is adapted to vary a settling time of the proportional regulator.

50. A system according to claim 48, wherein the control system is adapted to vary or dampen an amplitude of cycles of the proportional regulator.

51. A system according to claim 48, wherein the control system is adapted to vary the settling time and/or the amplitude as a function of the temperature of the heating and/or cooling medium.

52. A system according to claim 48, wherein the control system is adapted to vary the settling time and/or the amplitude as a function of an average of a feed and a return temperature of the heating and/or cooling medium.

53. A system according to claim 36, comprising wireless communication devices for devices for transmitting data between the control system and at least one of said devices, sensors, valves, and regulators

54. A system according to claim 36, wherein the control system is adapted to change the feed temperature.

55. A method for controlling a temperature of a plurality of rooms via a heating and/or cooling system with a central heating and/or cooling unit and a control system for at least partly controlling the temperature of the rooms, the system comprising a supply medium temperature sensor for sensing a feed temperature of a heating and/or cooling medium being fed to the room by the heating and cooling system, and in each room:
a temperature-setting device for setting a set-point value for the temperature of the room, and
a room temperature sensor for determining a current room temperature,
the method comprising the steps of, for each room, determining a control value representing a difference between the set-point value for the room temperature and the current room temperature, and controlling the heating and/or cooling system based on the control values so as to change the current room temperatures, characterised in that the method further comprises the step of changing the control values for each room centrally via the control system.
